(19) United States
(12) Patent Application Publication
(10) Pub. No.: US 2011/0012387 A1
(43) Pub. Date: Jan. 20, 2011

(54) INJECTION-MOLDED MOLD-BEHIND SUN VISOR

(75) Inventors: Steven J. Cicholski, Holland, MI (US); Steven M. Davage, Hamilton, MI (US); Thomas S. Hodgson, Holland, MI (US)

Correspondence Address: DOBRUSIN & THENNISCH PC, 29 W LAWRENCE ST, SUITE 210, PONTIAC, MI, 48342, US

(73) Assignee: Johnson Control Technology Company, Holland, MI (US)

(21) Appl. No.: 12/865,157

(22) PCT Filed: Jan. 29, 2009
(86) PCT No.: PCT/US2009/032330

§ 371 Date: Jul. 29, 2010

Related U.S. Application Data
(60) Provisional application No. 61/025,198, filed on Jan. 31, 2008.

(51) Int. Cl. B60J 3/00; B29C 45/14

(52) U.S. Cl. 296/97.1; 264/242

(57) ABSTRACT

A sun visor for a vehicle is made by inserting a coverstock material into a mold and molding a core behind at least part of the coverstock material. The coverstock material is thus integrally connected to the core and will follow the contour of the core. The finished part can be made thinner, lighter and less expensively than through conventional methods

### PRIORITY

This application claims priority to U.S. Provisional Application No. 61/025,198 filed Jan. 31, 2008, the entire disclosure of which is incorporated herein by reference.

This invention is related to International Patent Application PCT/US08/50287, filed Jan. 4, 2008, the entire disclosure of which is incorporated herein by reference.

### BACKGROUND

1. Field of the Invention

This invention relates to sun visors for a vehicle and a method of manufacturing sun visors.

2. Related Art

Many vehicles include sun visors usable to shade the eyes of the vehicle's occupants. Such sun visors are conventionally manufactured by stretching a sheet of fabric or vinyl coverstock over a core. Typically, the core is plastic. If the coverstock is not connected to the core, the coverstock will stretch across any gaps or concave surfaces of the core. For this reason, after forming the core, the coverstock is often glued, or otherwise attached, to the underlying core at least in the areas around any gaps or concave surfaces. However, many cores are made of materials to which adhesives do not readily adhere. With such materials, the plastic core must be pre-treated, such as, for example, by plasma etching, to roughen the surface of the core before the adhesive can be successfully applied. Alternatively, the sun visor may be designed with convex surfaces which do not require the coverstock to be fixed to the underlying core and/or attachments, such as a vanity, may be used to hold the coverstock against the underlying core. Conventional coverstock materials are also typically not very flexible and do not readily change shape to adhere to irregularities in the shape of the core.

### SUMMARY

This invention relates to a method of producing a sun visor for a vehicle comprising: providing a coverstock material, placing the coverstock material in an open mold, closing the mold, and injecting a molten plastic material into the mold and behind at least part of the coverstock material creating a plastic core.

This invention also relates to a sun visor comprising a core molded onto a coverstock material wherein at least one button profile is provided in the plastic core by the absence of the plastic material on at least some sides of the button profile.

This invention also relates to a sun visor comprising a core molded onto a coverstock material wherein the core includes two halves attached by a living hinge.

These and other features and advantages of various exemplary embodiments of systems and methods according to this invention are described in, or are apparent from, the following detailed descriptions of various exemplary embodiments of various devices, structures, and/or methods according to this invention.

### BRIEF DESCRIPTION OF THE DRAWINGS

Various exemplary embodiments of the systems and methods according to this invention will be described in detail, with reference to the following figures, wherein:

FIG. 1 is a fragmentary perspective view of a vehicle including one exemplary embodiment of a sun visor according to this invention;

FIG. 2 is a perspective view of two halves of a first exemplary embodiment of a sun visor according to this invention;

FIG. 3 is a perspective view of a conventional sun visor;

FIG. 4 is a perspective view of a second exemplary embodiment of a sun visor according to this invention;

FIG. 5 is a partial cross-sectional view of the sun visor of FIG. 4, as seen along line 5-5;

FIG. 6 is a schematic view of a third exemplary embodiment of a sun visor according to this invention; and

FIG. 7 is a partial cross-sectional view of the sun visor shown in FIG. 6, as seen along line 7-7;

FIG. 8 is a top schematic view of an exemplary embodiment of a button usable with the exemplary embodiment of a sun visor shown in FIGS. 6 and 7;

FIG. 9 is a schematic view of a fifth exemplary embodiment of a sun visor according to this invention;

FIG. 10 is a partial cross-sectional view of the sun visor of FIG. 9, as seen along line 10-10;

FIG. 11 is a partial cross-sectional view of a sixth exemplary embodiment of a sun visor according to this invention.

FIG. 12 is a perspective view of a sixth exemplary embodiment of a sun visor according to this invention;

FIG. 13 is a partial cross-sectional view of the sun visor of FIG. 12, as seen along the line 13-13; and

FIG. 14 is a partial cross-sectional view of the sun visor of FIG. 12, as seen along the line 13-13

### DETAILED DESCRIPTION

By using a mold-behind process to create a sun visor, concave surfaces, gaps, and/or other textured effects can be designed into the sun visor. Additionally, a sun visor produced using an injection mold-behind process may be thinner and/or less costly to manufacture, while offering more customizable options and a wider range of shapes.

This invention relates to a sun visor for a vehicle that is made by injection molding plastic behind one or more sheets of fabric, vinyl, or other coverstock material. The coverstock of the sun visor may be fabric, vinyl, polypropylene film, or any other coverstock material that is able to withstand the injection molding process. In some instances, the coverstock material is chosen according to particular qualities. For example, some coverstock materials may be chosen, at least in part, due to their ability to reduce the presence and/or appearance of injection molding artifacts in the show surface of the sheet(s) of coverstock. The coverstock material may also be chosen, at least in part, due to its ability to be injection molded behind without altering the appearance of its show surface.

This invention further relates to a sun visor for a vehicle that has buttons, button surfaces, button areas, and/or the like provided in a core that has been molded behind the coverstock material of the sun visor. The buttons, button surfaces, button areas, and/or the like may interact with internal switches to control any aspect of the vehicle.

This invention also relates to a method of producing a sun visor. The method includes placing one or more piece(s) of coverstock in an injection mold. The mold is then closed and molten plastic is then injected behind the piece(s) of coverstock. The plastic bonds to the coverstock as it hardens, such that the plastic and the coverstock are molded to the desired shape. In some exemplary embodiments, a blowing agent is used during the injection process to help the core material to flow into all of the cavities of the mold.

This invention further relates to a sun visor injection molded in a clam-shell design. The clam-shell design has two halves that are connected to each other by a living hinge. During final assembly, the two halves are folded onto each other so that a show surface of the sun visor is visible on all sides and a plastic core is in the interior of the sun visor. The living hinge may be formed by the plastic core of the sun visor and/or by the coverstock provided around, and bound to, the core. Any adjacent edges or portions of the two halves may be heat plated together, glued together, snapped together, or mechanically, adhesively, or otherwise attached to each other.

This invention further relates to a sun visor injection molded as two separate parts. Each part includes a core portion injection molded behind and bound to coverstock material. The separate parts may then be connected together and sealed by any suitable means, such as, for example, heat plating and/or gluing.

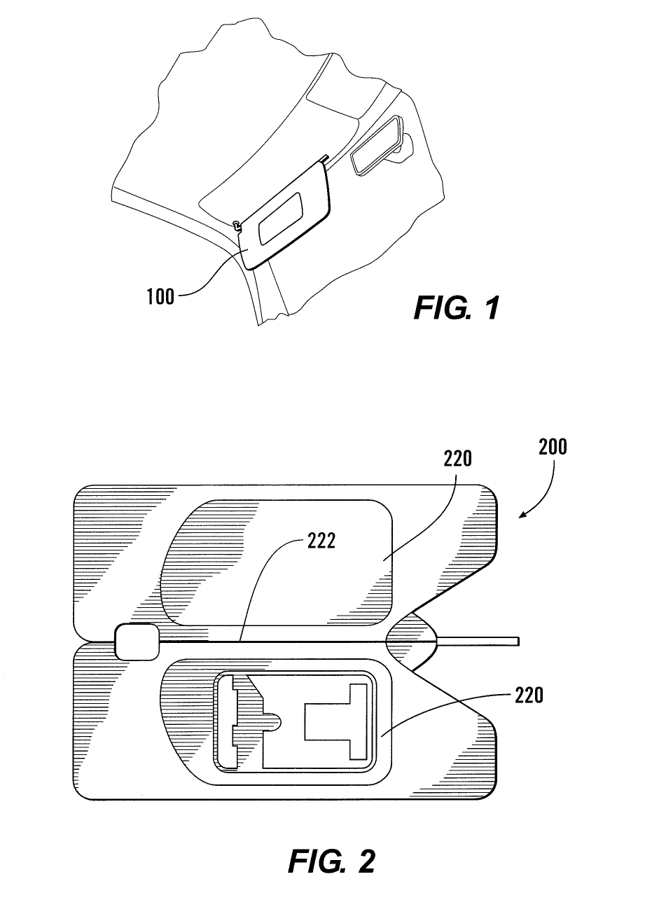

FIG. 1 shows an exemplary embodiment of a sun visor 100 in a downturned position. Sun visors may be used in vehicles to shield vehicle occupants from sunlight or glare. Sun visors may include other components, such as vanity lights, mirrors, controls, displays, holding slots, sunglass holders, etc.

FIG. 2 shows a first exemplary embodiment of a sun visor 200 according to this invention. As shown in FIG. 2, the sun visor 200 is manufactured as two halves 220. The two halves 220 may be separate pieces, or the two halves 220 may be connected to each other by a living hinge 222. During manufacture, the two halves 220 are folded or placed onto each other and any unsealed edges may be sealed by any suitable known or later-developed technique, such as heat plating, gluing and/or snaps. By folding or placing the two halves 220 together, the plastic core parts of each half 220 can be located in the interior of the sun visor 200, while the coverstock layer of each half 220 forms the show surface of the sun visor 200. In various exemplary embodiments, the core may be formed from any material capable of being injection molded. Appropriate materials may include various thermoplastics and/or resins.

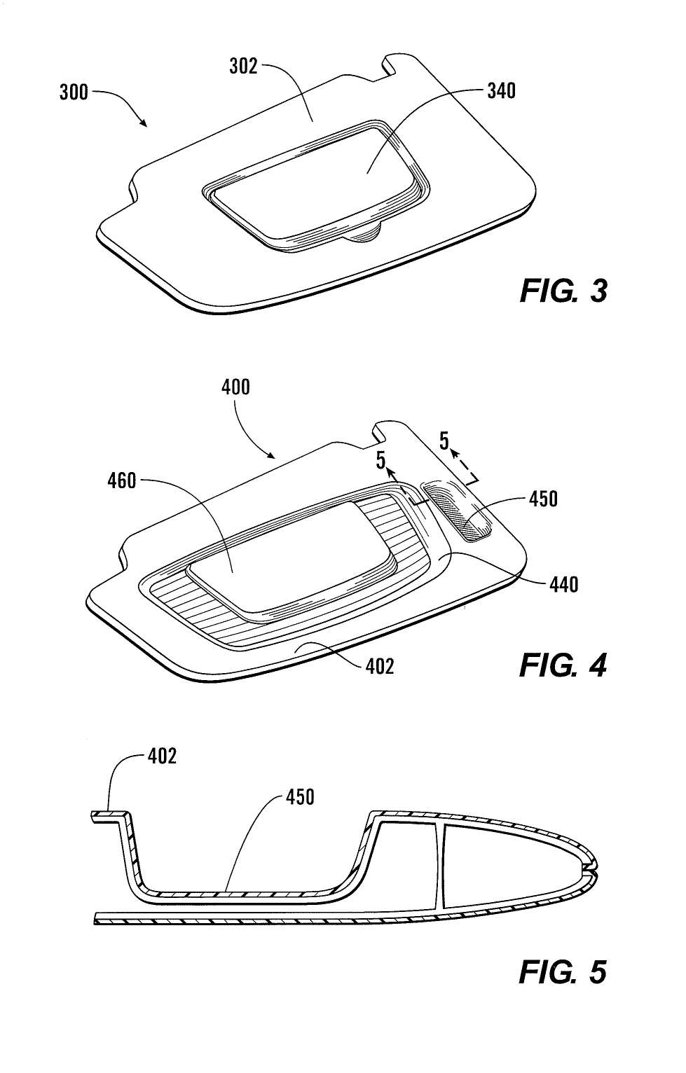

FIG. 3 shows a conventional sun visor 300. The conventional sun visor 300 has an inner core and a fabric covering 302 wrapped around the inner core. The fabric covering 302 will stretch across any gaps or concave surfaces in the contour of the conventional sun visor 300. For this reason, the conventional sun visor 300 is traditionally made with convex surfaces and/or the fabric covering 302 is glued or otherwise attached to the inner core after the core is manufactured. The gluing process requires extra steps, increases costs, and uses possibly harmful chemicals. Alternatively, features, such as the vanity 340, may be used to hold the fabric covering 302 against the core, with or without otherwise adhering the fabric covering 302 to the core.

In contrast, FIG. 4 shows a second exemplary embodiment of a sun visor 400 according to this invention that is manufactured using an injection mold-behind process, as outlined above. By injection molding a core of the sun visor 400 behind a coverstock layer 402, the core becomes integrally attached to the coverstock layer 402. Attaching the core to the coverstock layer 402 allows the sun visor 400 to have concave surfaces, such as a sloping surface 440, without the coverstock layer 402 stretching across the concave surfaces. Additionally, textured surfaces, such as the ridges 460, can be provided in the sun visor 400. Again, attaching the core to the coverstock layer 402 by injection molding the core behind the coverstock layer 420 allows the coverstock layer 420 to follow the contour and/or texture of the core without stretching over any gaps, concave surfaces, and/or the like, and without needing any post-core-forming steps to attach the coverstock layer 402 to the core. FIGS. 4 and 5 also illustrate an exemplary handle or hand grip 450. Hand grip 450 is formed during the molding process as a depression on one or both sides of the visor 300. It should be appreciated that although the hand grip 450 is shown at one end of the sun visor 300, it may be placed on other locations on the sun visor 300. It should be appreciated that any mechanism now known or later developed may be used to hold the coverstock layer 402 in place when placing the coverstock in the mold.

It should be appreciated that other textures or surface details are possible. For example, company logos and/or brand names can be designed into the mold to be visible in the show surface of the sun visor 400. In some embodiments, the coverstock layer 402 will be screen-printed or otherwise provided with images and/or patterns before the coverstock layer 402 is placed in the mold. In various exemplary embodiments, a label may be insert molded onto the fabric during the mold-behind process. A label is inserted into the tool, fabric is placed over the label, and molten plastic is injected into the tool on the opposite side of the fabric from the label. The heat and pressure of the molding process bonds the label to the fabric. In some exemplary embodiments, an adhesive may be placed between the fabric and the label.

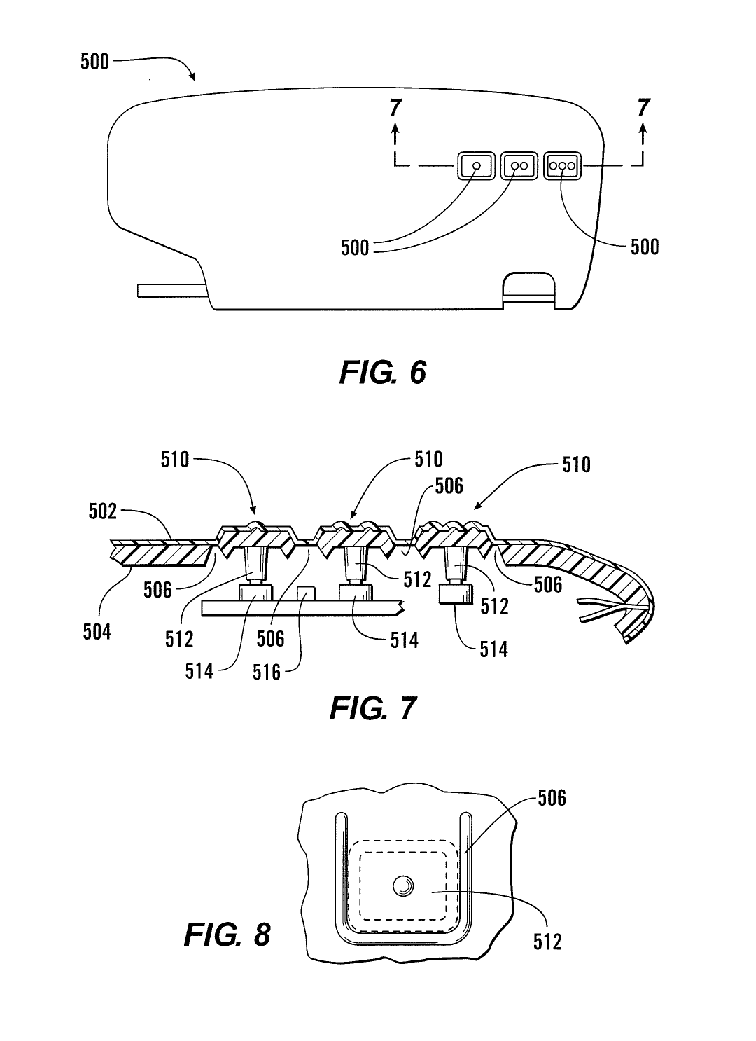

FIG. 6 shows a third exemplary embodiment of a sun visor 500 according to this invention. As shown in FIG. 6, the sun visor 500 includes three button regions 510. The button regions 510 can be used to interact with buttons 512 and switches 514 (shown in FIG. 7) that control any function of the vehicle. For example, the buttons 512 may be configured to control a HomeLink® system of the vehicle. The interaction between the button regions 510 and the buttons 512 is shown in FIG. 7.

FIG. 7 shows a side cross-sectional view of the sun visor 500. As shown in FIG. 7, the sun visor 500 comprises a coverstock layer 502 and a plastic core 504. The coverstock layer 502 may be made of any suitable material, such as fabric, vinyl, polypropylene film, and/or any other appropriate known or later-developed material. The sun visor 500 is made by placing the coverstock layer 502 in a mold, closing the mold, and injection molding plastic behind the coverstock layer 502 to form the plastic core 504. During the injection molding process, any molding artifacts in the coverstock layer 502 are desirably reduced, and ideally, the coverstock layer 502 is not altered in appearance. That is, molding artifacts are preferably reduced and ideally avoided or not created and/or visible in the coverstock layer 502. Particular materials may be used as the coverstock layer 502 based, at least in part, on that material's ability to limit or eliminate molding artifacts and/or visible changes during the injection molding process.

In the exemplary embodiment shown in FIGS. 6 and 7, the sun visor 500 has three buttons 512 that interact with switches 514 that control different functions of the vehicle. The buttons 512 are created when molding the plastic core 504. That is, the mold will have structures necessary to form the buttons 512 out of the same material and in the same process as the plastic core 504. Each button 512 is substantially aligned with a button region 510 of the coverstock layer 502. The button region 510 is visible from the exterior of the sun visor 500 and allows a user to interact with the buttons 512. It should be appreciated that the incorporated '287 application discloses thin film buttons of various types and that any embodiment of a button according to the '287 application can be used with the sun visor 100.

Gaps 506 are provided in the plastic core 504 and outline at least two sides of each button region 510. In the exemplary embodiment shown in FIGS. 6 to 8, and as best shown in FIG. 8, the gaps 506 outline three sides of each button region 510. Beneath the gaps 506 may be an LED 516 or other light source. The LED 516 may be used to back light the button profile and may illuminate other graphics or images on or around the button region 510.

It should be appreciated that the gaps 506 may be provided by any suitable means. For example, the gaps 506 may be created during the injection molding process by “shutting off” the mold, i.e., by pressing the mold against the coverstock layer 502 so that the plastic used to create the plastic core 504 does not flow into the areas of the gaps 506 during the injection molding process. Alternatively, the gaps 506 may be cut out after the molding process has been completed. The gaps 506 may be cut by any suitable known or later-developed process including laser or mechanical scribing. The plastic material can be omitted entirely in one or more of the button regions 510 of the coverstock layer 502 if the coverstock material can adequately cover the underlying switch(s) 514 and withstand activation of the switch(s) over the lifetime of the vehicle.

In various exemplary embodiments, the button region 510 is formed by placing gaps 506 on three of four sides of the button region 510. In other exemplary embodiments, there may be two or four gaps 506 on the sides of button region 510. In embodiments with a gap 506 on all four sides, an additional gate may be provided at each button region 510 to properly inject the molten plastic and a foam donut may be added behind the button region 510 to provide support to the button region 510.

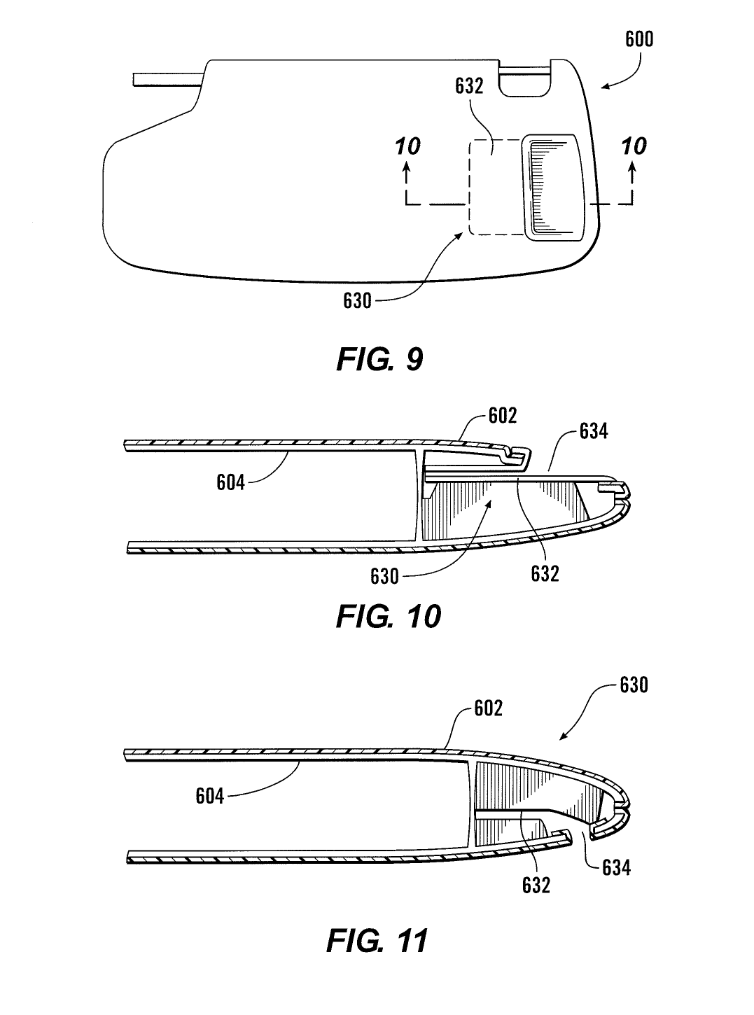

FIGS. 9 and 10 show a sun visor 600 with an exemplary ticket holder 630. The ticket holder is formed from a pocket 632 in the core 604 and a slot 634 in the coverstock layer 602. A pocket 632 may be formed in the core 604 and/or behind a portion of the coverstock layer 602 and/or a slot 634 formed in the coverstock layer 602. A pocket 632 may be formed by “shutting off” the mold, i.e., by pressing the mold against the coverstock layer 602 so that the plastic used to create the plastic core 604 does not flow into the areas of the pocket 632 during the injection molding process. Alternatively, the pocket 632 may be cut out after the molding process has been completed. The pocket 632 may be cut by any suitable known or later-developed process, including, for example, laser or mechanical scribing. As exemplified by FIG. 11, it should be appreciated that holder 630 may be altered in shape and/or size to make it capable of holding a variety of objects including, for example, cards, tickets, or writing utensils. It should be appreciated that pocket 632 may also be used to form attachment points for various components.

In various exemplary embodiments, the pocket and/or the slot may be formed by a variety of methods. For example, it may be die cut, laser cut, or water-jet cut. It may also be formed separately and inserted into the mold prior to injection molding the plastic core. In various exemplary embodiments, the pocket may be supported and/or held in place before, during, and/or after molding the core by internal ribs. In various exemplary embodiments, the slot may be cut in the fabric prior to molding the plastic core, in the mold when it is closed, or after molding the plastic core. In various exemplary embodiments, the edges of the slot may be reinforced by, for example, stitching or a trim out bezel.

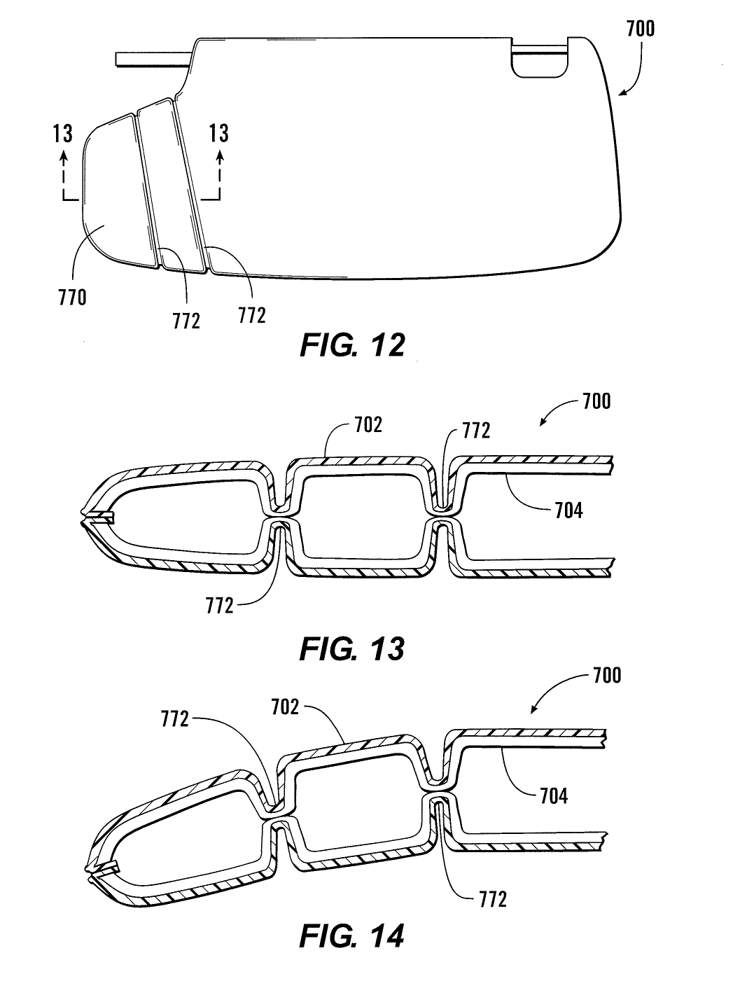

In various exemplary embodiments, as illustrated in FIGS. 12 to 14, the sun visor 700 may include a flexible ear 770. The ear 770 of the sun visor 700 is able to flex or bend to fit more closely against the roof or side pillars. The ear 770 bends are one or more hinges 772 comprised of a relatively narrow section in the sun visor core 704. The ear 770 is able to bend as shown in FIGS. 13 and 14. Hinges 772 are formed of a thin layer of the sun visor core 704 that is able to flex or bend. It should be appreciated that the sun visor 700 may also be made with a more rigid ear 770 that is straight or bent.

In various exemplary embodiments, a thermoplastic sheet adhesive may be placed between the injection molded core and the coverstock material. The thermoplastic sheet adhesive may be placed on the coverstock material before or after the coverstock material is placed in the mold.

In some embodiments, a blowing agent may be added to the molten plastic used to form the core, to help the molten plastic in flowing into the recesses of the mold during the injection molding process. The blowing agent is particularly useful when the mold includes small and/or intricate patterns such as the ribs 360. The blowing agent reduces the viscosity of the molten plastic and allows it to flow into the small and/or intricate pattern areas of the mold. The blowing agent can also be used to aid in forming thicker areas so that sink can be reduced, and ideally avoided.

It should be appreciated that the sun visor 100 is a three-dimensional object that has show surfaces on all exterior surfaces. That is, there is no hidden exterior surface of the sun visor that is out of sight to a user of the vehicle, in contrast to, for example, a door panel which will have a show surface and a back unseen surface. As such, the sun visor will be covered with the coverstock material on all sides.

In various exemplary embodiments, the fabric (e.g., covergood) and plastic may be trimmed directly in the mold tool to add holes (e.g., vanity mounting, ticket clip slot, or button holes) and to cut off the perimeter of the fabric. In various other exemplary embodiments, a secondary operation such as, for example, a punch die, laser cut, or waterjet cut, may be used.

While this invention has been described in conjunction with the exemplary embodiments outlined above, various alternatives, modifications, variations, improvements, and/or substantial equivalents, whether known or that are or may be foreseen, may become apparent to those having at least ordinary skill in the art. Accordingly, the exemplary embodiments of the invention, as set forth, are intended to be illustrative, not limiting. Various changes may be made without departing from the spirit or scope of the invention. Therefore, the invention is intended to embrace all known or earlier developed alternatives, modifications, variations, improvements, and/or substantial equivalents.

What is claimed is:

1. A sun visor, comprising:
a core molded onto a coverstock material;
wherein the core includes two halves attached by a living hinge.

2. (canceled)

3. (canceled)

4. The sun visor of claim 1 further comprising at least one button profile is provided in the plastic core by the absence of the plastic material on at least some portions of the button profile.

5. The sun visor of claim 4 wherein at least one button profile is provided in the plastic core by the absence of the plastic material on two, three, or four of four sides of the button profile.

6. The sun visor of claim 1 wherein the core is a thermoplastic.

7. The sun visor of claim 1 wherein the core is a fully bonded resin.

8. The sun visor of claim 1 wherein the coverstock material comprises a fabric, a vinyl, and/or a polypropylene film.

9. The sun visor of claim 1 further comprising:
forming a pocket in the plastic core; and
forming a slot in the coverstock material;
wherein the slot is in communication with the pocket.

10. The sun visor of claim 1 wherein there is no adhesive bonding the coverstock material to the core.

11. The sun visor of claim 1 further comprising a thermoplastic adhesive between the core and the coverstock material.

12. A sun visor, comprising a plastic core molded onto a coverstock material wherein at least one button profile is provided in the plastic core by the absence of the plastic material on at least some portions of the button profile.

13. The sun visor of claim 12 wherein at least one button profile is provided in the plastic core by the absence of the plastic material on two, three, or four of four sides of the button profile.

14. The sun visor of claim 12 wherein the sun visor comprises two pieces in a clam shell design joined by a living hinge.

15. (canceled)

16. (canceled)

17. The sun visor of claim 12 wherein the core is a thermoplastic.

18. The sun visor of claim 14 wherein the core is a fully bonded resin.

19. The sun visor of claim 12 further comprising three button profiles.

20. The sun visor of claim 12 wherein the coverstock material comprises a fabric, a vinyl, and/or a polypropylene film.

21. The sun visor of claim 12 further comprising:
a pocket in the plastic core; and
a slot in the coverstock material;
wherein the slot is in communication with the pocket.

22. The sun visor of claim 12 wherein there is no adhesive bonding the coverstock material to the core.

23. The sun visor of claim 12 further comprising a thermoplastic adhesive between the core and the coverstock material.

24. A method of producing a sun visor for a vehicle, comprising:
providing a coverstock material;
placing the coverstock material in an open mold;
closing the mold; and
injecting a molten plastic material into the mold and behind at least part of the coverstock material creating a plastic core.

25. The method of claim 24 wherein at least one button profile is provided in the plastic core by the absence of the plastic material on at least some portions of the button profile.

26. The method of claim 24 wherein the button profile is provided in the plastic core by the absence of the plastic material on two, three, or four of four sides of the button profile.

27. The method of claim 24 further comprising:
forming a living hinge; and
folding the sun visor along a living hinge.

28. The method of claim 24 wherein the living hinge is formed from the coverstock material

29. (canceled)

30. The method of claim 24 further comprising joining two separate halves of the sun visor.

31. The method of claim 24 further comprising sealing the sun visor.

32. The method of claim 24 further comprising adding a blowing agent to the molten plastic material prior to injecting the molten plastic is injected into the mold.

33. The method of any of claims 24 through 32 wherein the molten plastic material comprises a thermoplastic.

34. (canceled)

35. The method of claim 24 wherein the molten plastic material comprises a fully bonded resin.

36. The method of claim 24 wherein the coverstock material comprises at least one of a fabric, a vinyl, and/or a polypropylene film.

37. The method of claim 24 further comprising:
a pocket in the plastic core; and
a slot in the coverstock material;
wherein the slot is in communication with the pocket.

38. The sun visor of claim 24 wherein there is no adhesive bonding the coverstock material to the injection molded core.

39. The sun visor of claim 38 further comprising applying a thermoplastic sheet adhesive to the coverstock material before injecting the molten plastic material.
